(19) United States
(12) Patent Application Publication
(10) Pub. No.: US 2026/0161640 A1
(43) Pub. Date: Jun. 11, 2026

(54) SEARCH QUERY GENERATION SYSTEM FOR COMPREHENSIVE DATA MAPPING AND RETRIEVAL

(71) Applicant: HITACHI, Ltd., Tokyo (JP)

(72) Inventor: Takuya HABARA, Santa Clara, CA (US)

(21) Appl. No.: 18/974,705

(22) Filed: Dec. 9, 2024

(51) Int. Cl. G06F 16/242; G06F 16/2455; G06F 16/25

(52) U.S. Cl. CPC G06F 16/2425; G06F 16/2455; G06F 16/254

(57) ABSTRACT

Systems and methods herein utilize data from various data sources in a production environment to first configure connections between a data utilization platform and the data sources using system information from a system information database. Interactions between data sources are monitored and recorded in the system information database. Relationships between the data sources are generated based on these interactions. In response to a user query, contextual information is added from a context database to generate a regenerated query. A subset of data sources associated with the regenerated query is identified based on query criteria or stored relationships. Unstructured camera data is then cross-referenced with this subset, thereby eliminating the need for computer vision models to interpret camera content. ETL code is generated to retrieve relevant data from the subset based on the regenerated query.

### BACKGROUND

### Field

The present disclosure is generally directed to data utilization platforms, and more specifically, to systems and methods for enhancing data retrieval accuracy in a distributed production environment using contextual query processing.

### Related Art

Today, many companies are engaged in digital transformation initiatives. Digital transformation involves leveraging digital technologies to improve operational efficiency and create added value. In digital transformation, various systems are integrated and data is shared. For instance, digital transformation in a factory setting involves employing operational systems, such as enterprise resource planning (ERP), product lifecycle management (PLM), and manufacturing execution systems (MES), alongside video capture systems, such as ceiling cameras, robotic systems, including arm robots and autonomous mobile robots (AMR), and worker support systems, such as wearable devices. Data from each system is often stored in a relational database (RDB), time series database, or object storage system. These systems and databases typically connect to a data utilization platform.

Users seek to leverage this data for business improvements. Data targeted for utilization includes not only structured and semi-structured data stored in RDBs and time series databases but also unstructured data, such as video data stored in an object storage. To meet user inquiries, the data utilization platform must be capable to search for and retrieve relevant information from a wide range of distributed data sources. Inquiries, often expressed in natural language, may not always be as uniquely defined as extract, transform, load (ETL) program code. For example, in the event of a production issue, such as an arm robot halting during a manufacturing process, a user might ask, “What caused the arm robot to stop?” In response, the data utilization platform aims to provide the user with information regarding the robot's operation, which may include sensor data and command logs from the MES, as well as ceiling camera images and wearable device camera images captured at the time of the robot halting.

In recent years, attempts have been made to extract desired data using Artificial Intelligence (AI). Various users such as business owners, system architects, on-site operators, data analysts, and maintenance technicians require tailored information to meet their specific needs. By leveraging AI, it is possible to search for the information needed by users. To improve the accuracy of information retrieval, the data utilization platform should accurately interpret and understand the meaning of data stored across the various data sources.

One existing approach to enhance data retrieval accuracy involves providing domain-specific information, while another approach calculates relevance scores and ranks data in response to queries. However, such methods primarily focus on estimating relevance between data sources and user queries. In many instances, this estimation alone is insufficient to achieve satisfactory accuracy. This is particularly true when the underlying meaning of the data within a source is poorly defined, or when a database store multipurpose data that lacks clear context or differentiation. Without a deeper understanding of the data's contextual relevance, such approaches fall short in delivering accurate results.

### SUMMARY

A search query generation method and system for information retrieval are disclosed. The system includes a module configured to identify systems relevant to a user query, where the relevant systems include unstructured data sources such as video and image data from multiple target systems. The system monitors data exchanges between the identified systems and records the storage systems and specific locations within those storage systems where data relevant to the user query is stored.

The system further includes a module configured to associate a video or image generation system, or a video or image storage system that does not directly interact with other systems, with the systems relevant to the user query. This association is performed by comparing timestamps of video or image changes with the operational execution history of relevant systems and determining whether the videos or images and the relevant systems capture the same event.

In cases of system mobility, such as when wearable devices or autonomous mobile robots are involved, the system is configured to identify and retrieve only data related to the events targeted by the user query. This is achieved by capturing the location and timestamps of each system at the time the targeted events occur and extracting data from the relevant systems based on their relation to the event and corresponding timestamps.

Additionally, the system includes a module to utilize a recorded history of past query events and successful query patterns to improve search accuracy and efficiency. This module maintains a history log of successful query patterns and associated systems, and allows a user to configure mappings of related systems and data sources to streamline future queries based on these mappings.

In some aspects of the disclosure, method for utilizing data from multiple data sources comprises: using system information stored in a system information database to configure connections between a data utilization platform and data sources; monitoring one or more interactions between the data sources, and storing the one or more interactions in the system information database; generating relationships between the data sources based on the one or more interactions and storing the relationships in the system information database, at least one of the data sources may comprise unstructured data, wherein the relationships define associations between devices and data storage paths; in response to receiving a user query, adding contextual information to the user query to generate a regenerated query, the contextual information may be obtained from a context database that comprises information related to a management resource, a product lifecycle, a manufacturing execution, a database address, a data type, or a directory name; using a source selector to identify, based on matching query criteria or the relationships, a subset among the data sources, the subset being associated with the regenerated query, which may comprise a relevant timestamp, a robot ID, or system status information, wherein the system information comprise a system name, system ID, IP address, port number, installation location, or related operations, and wherein the data sources comprise a relational database, a time series database, video data, or image data; and cross-referencing unstructured data, which has been obtained from a device, with the subset based on the relationships. Cross-referencing unstructured data may eliminate a need to train a computer vision model for object detection to interpret content captured by camera data.

Some aspects further comprise associating data from a wearable device with corresponding system instructions based on the one or more interactions recorded in the system information database. The interactions may comprise an API request, sensor data, a system log, or an operational instruction between the data sources through an API gateway or a network scanning unit.

In some aspects, generating the relationships may be based on a data exchange pattern or a unique identifier from the system information, the unique identifier comprising a system ID, a port number, an IP address, or a temporal alignment of two or more interactions. Attributes of the interactions may include a source address, a destination address, an execution time, a data size, or a frequency of exchange, an IP address, a MAC address, a database table name, a column name, or a path in an object storage system.

Some aspects may further comprise prompting a user to provide additional system information during a configuration of the connections between the data utilization platform and the data sources; or using the subset to enable an ETL code to retrieve the data from the subset based on the regenerated query, wherein the ETL code is generated in response to the regenerated query and the subset to extract, transform, and load data into a user-accessible format.

In some aspects, a system for utilizing data from multiple data sources may comprise a system information database configured to store system information and interactions between data sources; a data utilization platform including: a system connection configuration unit configured to use the system information stored in the system information database to configure connections between the data utilization platform and the data sources; a data exchange measurement unit configured to monitor the interactions through an API gateway or a network scanning unit and to store the interactions in the system information database; an inter-system relationship configuration unit configured to generate relationships between the data sources based on the interactions stored in the system information database, wherein at least one of the data sources includes unstructured data, and wherein the relationships define associations between devices and data storage paths; a context addition unit configured to add contextual information from a context database to a user query, thereby generating a regenerated query; and a data source selector configured to identify, based on matching query criteria or the relationships, a subset of data sources associated with the regenerated query, wherein the data utilization platform is configured to associate unstructured data, which has been obtain from a device, with the subset based on the relationships.

Some aspects may further comprise an execution code generator configured to generate ETL code to retrieve data from the subset based on the regenerated query.

In some aspects, the interactions may comprise an API request, sensor data, a system log, or an operational instruction between the data sources through an API gateway or a network scanning unit.

In some aspects, associating the unstructured data with the subset eliminates a need to train a computer vision model for object detection to interpret content captured by camera data.

In some aspects, the data utilization platform may further be configured to associate data from a wearable device with corresponding system instructions based on the interactions recorded in the system information database.

In some aspects, the inter-system relationship configuration unit generates the relationships based on a data exchange pattern or a unique identifier from the system information, the unique identifier comprising a system ID, a port number, an IP address, or a temporal alignment of two or more of the interactions.

In some aspects, the regenerated query may comprise a relevant timestamp, a robot ID, or system status information, wherein the system information comprises a system name, a system ID, an IP address, a port number, an installation location, or related operations, and wherein the data sources may comprise a relational database, a time series database, video data, or image data.

In some aspects, the attributes of the interactions may comprise a source address, a destination address, an execution time, a data size, a frequency of exchange, an IP address, a MAC address, a database table name, a column name, or a path in an object storage system.

In some aspects, the context database may comprise information related to a management resource, a product lifecycle, a manufacturing execution, a database address, a data type, or a directory name.

In some aspects, the techniques described herein relate to a non-transitory computer-readable medium for storing instructions for executing a process, the instructions including: using system information stored in a system information database to configure connections between a data utilization platform and data sources; monitoring one or more interactions between the data sources; storing the one or more interactions in the system information database; generating relationships between the data sources based on the one or more interactions and storing the relationships in the system information database, the data sources including unstructured data, wherein the relationships define associations between devices and data storage paths; in response to receiving a user query, add contextual information to the user query to generate a regenerated query; and using a source selector to identify based on matching query criteria or the relationships a subset among the data sources, the subset being associated with the regenerated query; and cross-referencing unstructured data, which has been obtain from a device, with the subset based on the relationships.

Aspects of the present disclosure can involve a system, which can involve means for using system information stored in a system information database to configure connections between a data utilization platform and data sources; means for monitoring one or more interactions between the data sources, and storing the one or more interactions in the system information database; means for generating relationships between the data sources based on the one or more interactions and storing the relationships in the system information database, at least one of the data sources may comprise unstructured data, wherein the relationships define associations between devices and data storage paths.

Aspects of the present disclosure can involve a system, which can involve means for adding contextual information to the user query, in response to receiving a user query, to generate a regenerated query; means for using a source selector to identify, based on matching query criteria or the relationships, a subset among the data sources, the subset being associated with the regenerated query, which may comprise a relevant timestamp, a robot ID, or system status information; and means for cross-referencing unstructured data, which has been obtained from a device, with the subset based on the relationships. Cross-referencing unstructured data may eliminate a need to train a computer vision model for object detection to interpret content captured by camera data.

### BRIEF DESCRIPTION OF DRAWINGS

FIG. 1 illustrates a system for utilizing data from multiple data sources in a production environment, according to various embodiments of the present disclosure.

FIG. 2 illustrates an example of systems operating within a production process, according to various embodiment of the present disclosure.

FIG. 3 illustrates an example of data exchange between the systems shown in FIG. 2, according to various embodiments of the present disclosure.

FIG. 4 illustrates state transitions within the data utilization platform illustrated in FIG. 1, according to various embodiments of the present disclosure.

FIG. 5 illustrates an example of system information provided by a user during a configuration process, according to various embodiments of the present disclosure.

FIG. 6 is a flowchart for inter-system relationship configuration status, according to various embodiments of the present disclosure.

FIG. 7 illustrates the relationships established between systems, according to various embodiments of the present disclosure.

FIG. 8 illustrates time-series of the activities of arm robots and corresponding movement of objects detected in the footage captured by the camera, according to various embodiments of the present disclosure.

FIG. 9 illustrates the relationships between systems as determined after verifying the contents of the data, according to various embodiments of the present disclosure.

FIG. 10 is a flowchart illustrating an exemplary process for utilizing data from multiple data sources according to various embodiments of the present disclosure.

FIG. 11 illustrates an example computing environment according to various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

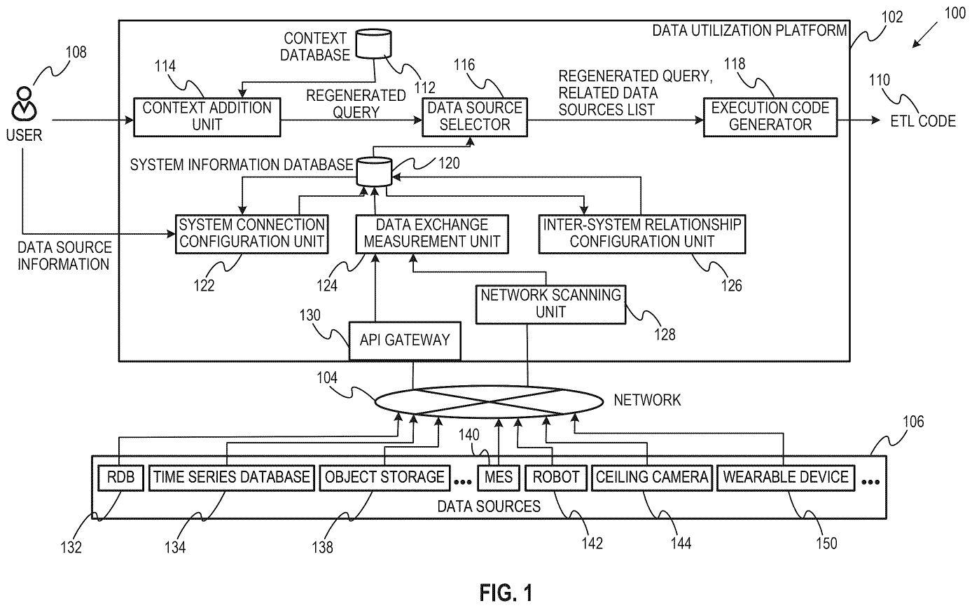

FIG. 1 illustrates a system for utilizing data from multiple data sources in a production environment, according to various embodiments of the present disclosure. As depicted, system 100 comprises data utilization platform 102 network 104, and data sources 106. In embodiments, data utilization platform 102 may comprise context database 112, context addition unit 114, data source selector 116, execution code generator 118, system information database 120, system connection configuration unit 122, data exchange measurement unit 124, inter-system relationship configuration unit 126, network scanning unit 128, and API gateway 130. Data sources 106 may comprise data systems such as data storage systems, e.g., RDB 132, time series database 134, object storage 138; production control systems, such as MES 140, robotic systems 142, such as arm robots and AMRs; video capture systems, such as ceiling camera 144; and worker support systems, such as wearable device 150. It is understood that the scope of data sources is not limited to these examples and may comprise multiple instances of each type.

System connection configuration unit 122 utilizes user-provided data sources information and system information database 120 to establish connections between data utilization platform 102 and data sources 106. Data sources information may comprise system name, system ID, IP address, port number, related operations, and installation location. Depending on the system configuration, not all of these details may be required, and additional information may be provided as needed.

In operation, data exchange measurement unit 124 tracks data exchanges between data sources 106. Data utilization platform 102 may act as part of each system's API endpoint, functioning as API gateway 130. When data is transmitted through API gateway 130, data exchange measurement unit 124 may record the exchanges in system information database 120. The recorded data may comprise details such as source and destination addresses, execution time, data size, and frequency of the exchange, although only some of these metrics might be recorded, or additional or alternative metrics may also be included. For example, data exchange measurement unit 124 may record details such as IP addresses, MAC addresses, database table names, column names, or paths in an object storage system.

In cases where data transmission bypasses API gateway 130, network scanning unit 128 may capture data exchanges within network 104 and record them in system information database 120. The captured data may comprise the source and destination addresses, execution time, data size, and frequency of the exchanges. Depending on system configuration, additional metrics like IP addresses, MAC addresses, database table names, column names, or paths in object storage systems may also be recorded.

Inter-system relationship configuration unit 126 may establish relationships between data sources 106 based on the information stored in system information database 120 and record these relationships therein. The relationships may comprise mappings, such as specific device and table names where instructions are stored, or a camera device ID and the path in object storage where corresponding images are saved.

Context addition unit 114 may use information from context database 112 to enhance a user query and generate a regenerated query that may incorporate additional background information. Context database 112 may comprise data related to management resources, product lifecycle, manufacturing execution, database addresses, data types, directory names, and the like. In embodiments, context addition unit 114 may leverage a Large Language Model (LLM) to generate the regenerated query.

Data source selector 116 may use information stored in system information database 120 to identify relevant data sources, e.g., in response to the regenerated query produced by context addition unit 114, e.g., to create a related data sources list. This list may comprise system names, system IDs, addresses, and may further comprise IP addresses, MAC addresses, database table names, column names, or paths in an object storage system. Data source selector 116 may use an LLM to generate the related data sources list.

Execution code generator 118 may refer to the regenerated query and the related data sources list to generate ETL code to retrieve the relevant data for the user. Execution code generator 118 may also employ an LLM to facilitate the generation of the ETL code.

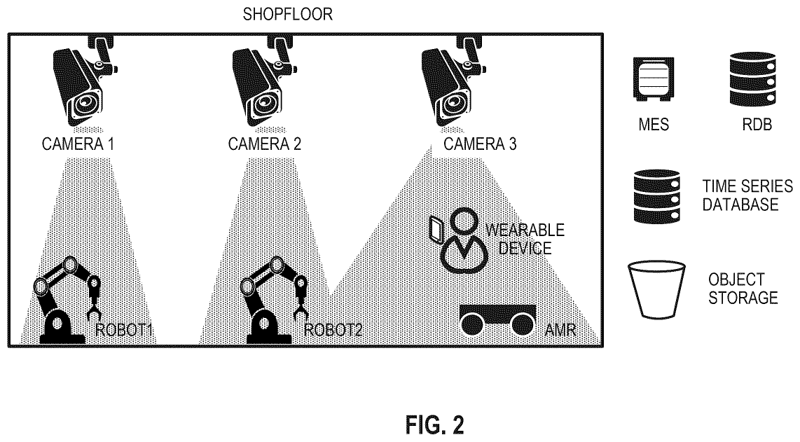

FIG. 2 illustrates an example of systems operating within a production process, according to various embodiment of the present disclosure. In this example, arm robot 1 142 and arm robot 2 144 execute tasks on the shop floor, e.g., based on instructions from MES 140. A user, equipped with a wearable device, may move around the shop floor and complete tasks as directed by MES 140. AMR 160 navigates the shop floor under instructions from MES 140, transporting parts to arm robots 142 and 143. Ceiling-mounted cameras, Camera1, Camera2, and Camera3 144-148 may be implemented as ceiling-mounted cameras that capture footage of the shop floor, each of camera 144-148 may cover a different area. RDB 132 is configured to manage the reading and writing of data related to the operations of MES 140. Time series database 134 stores data collected from encoders (not shown) associated with the movements and operations of arm robot 1 142 and arm robot 2 142. Additionally, object storage 138 holds video and still image data captured by Camera1, Camera2, Camera3 144-148, as well as from wearable devices, such as device 150.

It is noted that although the invention is generally described in the context of a production environment, it is understood that this is not intended to limit the scope of the present disclosure to such embodiments as the systems and methods for utilizing data from multiple data sources described herein may be used in various other applications.

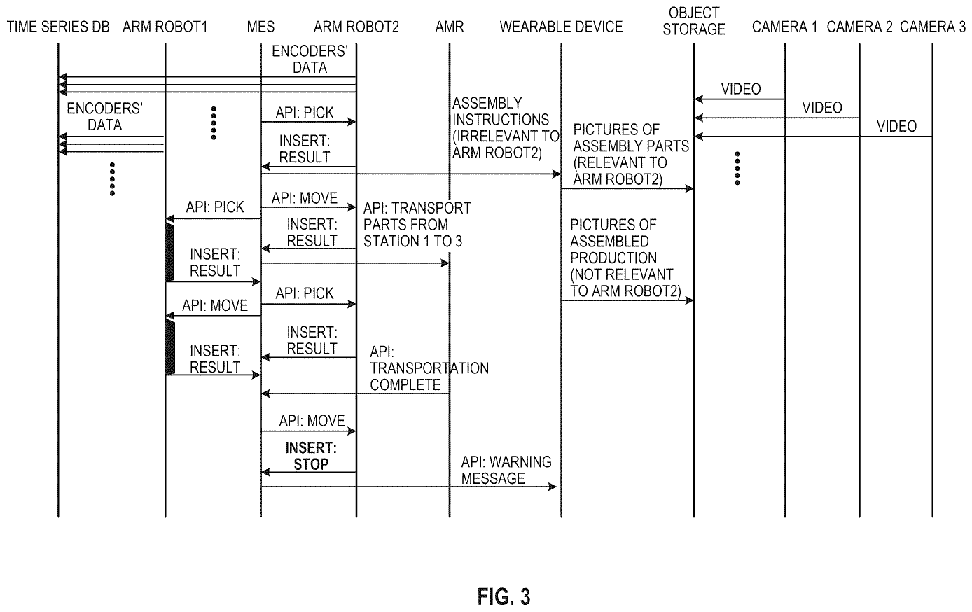

FIG. 3 illustrates an example of data exchange between the systems shown in FIG. 2, according to various embodiments of the present disclosure. In this embodiment, it is assumed that arm robot 2 143 has halted during the production process, and a user queried the data utilization platform (shown in FIG. 2) for data related to arm robot 2 143 in order to investigate the possible cause of the halt. Time series database 134 may continuously receive data 310 and 312 from respective encoders of arm robot 1 and arm robot 2. Exemplary data may comprise information such as
‘robot_encoders, robot_id=“JM-X7-001314,” joint=“rotary,” encoder_value=10917, velocity=5.6, position=0.12, [timestamp=] 2024-09-01T09:23:17Z’.

MES 140 issues work instructions to arm robot 1 142, e.g., by ending a request to the endpoint/api/user_program/execute comprising data such as
‘{“robot_id”: “robot1”, “program_id”: 21}’

Once arm robot 1 142 completes its task, it responds to MES 140 by sending data to the endpoint ‘/api/mes/notifyCompletion’ such as
‘{“robot_id”: “robot1”, “program_id”: 21, “status”: “completed”, “timestamp”: “2024-09-01T09:23:46Z”}’

Based on the received data, MES 140 may insert data into RDB 132 using a command such as
“INSERT INTO robot_execution_logs (robot_id, program_id, status, completion_timestamp) VALUES (‘robot1’, 21, ‘completed’, ‘2024-09-01 09:23:46’)”

Similar interactions may occur between MES 140 and arm robot 2 143, and between MES 140 and AMR 160.

In embodiments, MES 140 issues specific instructions to the user wearing wearable device 150, by sending data such as
“09:04 Go to arm robot2 and assemble the parts”

to endpoint/api/messages/instructions. Wearable device 150 may be equipped with a camera (not shown) and automatically or upon user action capture video or still images and storing them in object storage 138, for example, at a path
/WDEV-24/EMP2175/2024/09/01/09/03

Camera1 144 captures video and still images of the shop floor and stores them in object storage 138, for example, at path
/CAM-891/0c7e23/2024/09/01/09

Similar data exchanges may occur between MES 140 and Camera2 145 or Camera3 146. In this manner, the system tracks data exchanges and keeps track of where relevant data is stored, include associated data paths. As a person of skill in the art will appreciate, the data, endpoints, and path examples used in the description of FIG. 3 are for illustrative purposes only and are not limited to these instances.

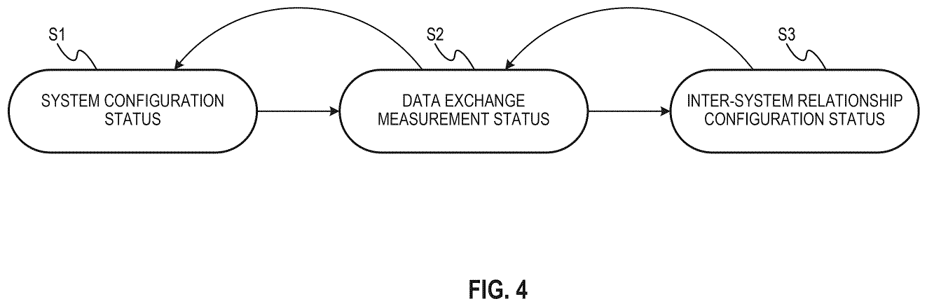

FIG. 4 illustrates state transitions within the data utilization platform illustrated in FIG. 1, according to various embodiments of the present disclosure. At system configuration status (S1), the system connection configuration unit configures connections between the data utilization platform and the data sources. In embodiments, this phase may involve configuring the data utilization platform based on the provided information to ensure that the data sources are properly linked to the data utilization platform for further data exchanges.

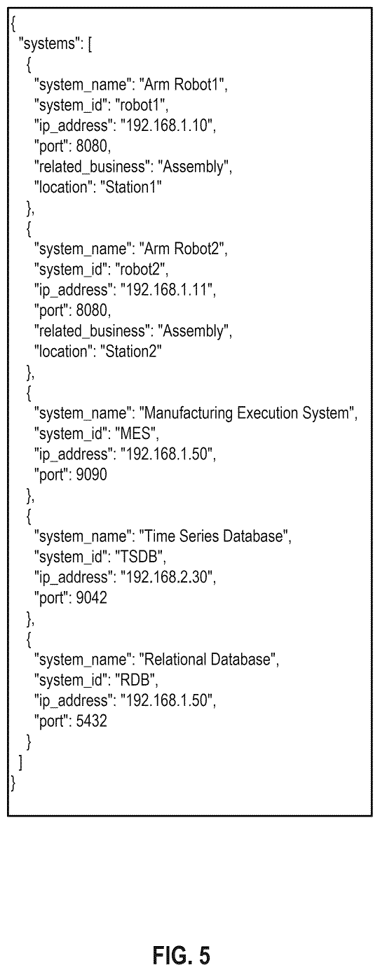

FIG. 5 illustrates an example of system information provided by a user during a configuration process, according to various embodiments of the present disclosure. In embodiments, if similar information already exists in the system information database, it may be reused. In embodiments, the system connection configuration unit establishes connections between the data utilization platform (hereinafter, “platform”) and the data sources. In cases where certain information, such as authentication credentials, is missing, the system may prompt the user for the necessary details. In embodiments, the system connection configuration unit may then display a list of successfully connected systems to the user to verify that all targeted devices are properly registered. Upon user confirmation, the platform may then transition to data exchange measurement status (S2).

At data exchange measurement status (S2), the data exchange measurement unit monitors and measures data exchanges between the connected data sources. These exchanges may be recorded in the system information database, as depicted in FIG. 3. If a new data source is detected, or a user requests the addition of a new data source, the platform may revert to system configuration status (S1). If a user executes a query, or if the platform determines that such is necessary, the state transitions to Inter-system relationship configuration status (S3).

At inter-system relationship configuration status (S3), an inter-system relationship configuration unit may establish and record the relationships between various data sources in the system information database, e.g., to ensure that data interactions and dependencies are properly mapped and updated.

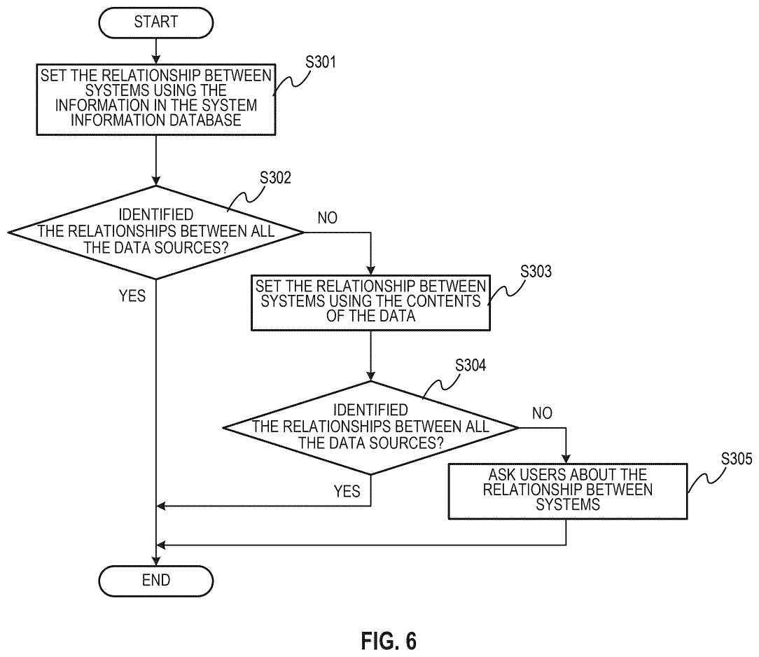

FIG. 6 is a flowchart for inter-system relationship configuration status (S3), according to various embodiments of the present disclosure. At step S301, the platform sets relationships between various systems utilizing information stored in the system information database.

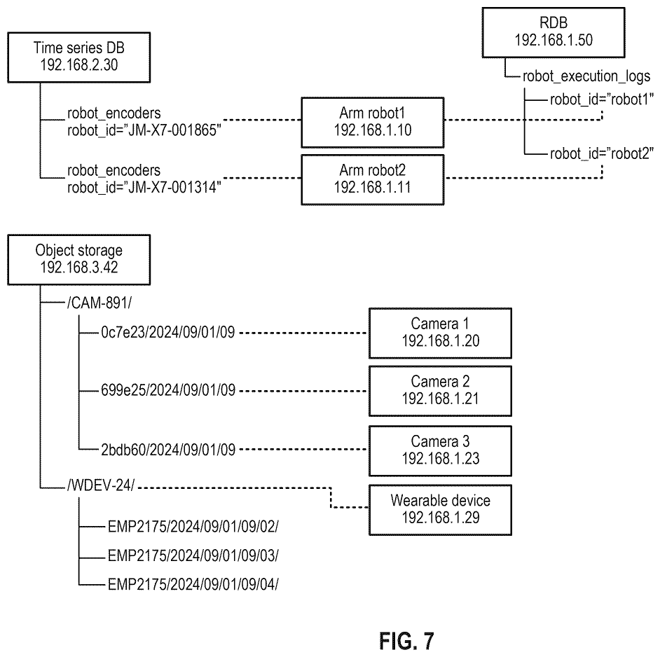

FIG. 7 illustrates the relationships established between systems, according to various embodiments of the present disclosure. For example, arm robot 1 is associated with the Time Series Database entry ‘robot_encoders, robot_id=“JM-X7-001865.”’ Although the identifier “JM-X7-001865” used by the arm robot differs from the name “arm robot 1” used in the MES, the data exchange measurement unit has determined, by analyzing data exchanges, that both identifiers refer to the same entity. Similarly, the relationship between the RDB and arm robot 1 can be identified. Arm robot 2 is associated in a similar manner. The relationships between cameras and object storage, and between the wearable device and object storage, may also be measured by the data exchange measurement unit, which determines which system's data is stored in which object storage path. For example, the MES data shows that while AMR was performing tasks unrelated to arm robot2, no direct data exchange occurred between the arm robots and the cameras, which indicates that their relationship cannot be easily determined.

Therefore, at step S302, the data utilization platform evaluates whether the relationships between the data sources have been fully ascertained. In this embodiment, since the relationship between the arm robots and the cameras remains unclear, the process resumes with Step S303.

At step S303, the data utilization platform further examines the contents of the data. For example, instructions sent from the MES to the wearable device reveal that, at time 9:04, the wearable device was in proximity to arm robot 2. Simultaneously, when data was transmitted from the wearable device to object storage, it was stored at the path “/WDEV-24/EMP2175/2024/09/01/09/04,” which allows the data utilization platform to associate this path's data with arm robot 2. Additionally, information from the encoders stored in the time series database is used to determine when the arm robots were active. By analyzing data from cameras stored in object storage, the platform can determine whether objects within the footage are moving without the need to identify whether the moving objects in the camera images are arm robots. As a result, no specialized training for robot motion detection in camera images is required in this process.

Structured data, such as data in RDBs, time series data, and API execution records are typically well-defined and interconnected, which makes their relationships with other systems relatively straightforward to establish and interpret.

In contrast, camera data presents a unique challenge due to its independent operation and often lacks direct contextual relationships with other systems. Embodiments of the present disclosure overcome this difficulty by associating camera data with other data sources without the need for object-level interpretation.

Traditionally, camera images only capture movement without recognizing specific objects or events. Embodiments herein eliminate of the requirement of having to rely on computer vision (CV) models to interpret the content of video footage, instead associating camera data with other relevant data sources through contextual relationships. By leveraging the broader data context from various sources, the system relates camera data to relevant events without the need for complex machine learning models for object recognition, simplifying the process of integrating camera data into the overall analysis.

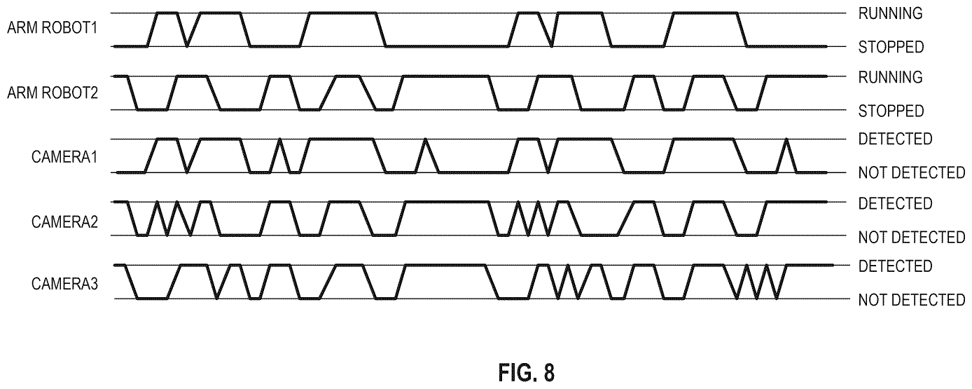

FIG. 8 illustrates time-series of the activities of arm robots and corresponding movement of objects detected in the footage captured by the camera, according to various embodiments of the present disclosure. Encoder data in the time series database indicates the timing of arm robot movements. At the same time, video data from cameras in object storage allows the platform to detect movement in the footage. At this point, it is unnecessary to determine whether a moving object in the camera footage is an arm robot or not, thus eliminating the for specialized training for robot motion detection in images.

In FIG. 8, the activity of arm robot 1 has a 94% match with motion detected by Camera 1, but only respective 46% and 44% matches with Camera 2 and Camera 3. As a result, arm robot 1 can be associated with Camera 1. Similarly, the activity of arm robot 2 matches 94% and 90% with the motion detected by Cameras 2 and 3, respectively, but has only a 43% match with Camera 1. Thus, arm robot 2 can be associated with Cameras 2 and 3. From FIG. 2, it can be seen that even if Camera 3 has not been set up to capture pictures of arm robot 2, it still recorded the movements of arm robot 2, which is reflected in the footage of Camera 3. This demonstrates that an advantageous feature of such embodiment is that even data sources that have not been directly specified by a user, can still be identified and utilized as data sources of relevant data.

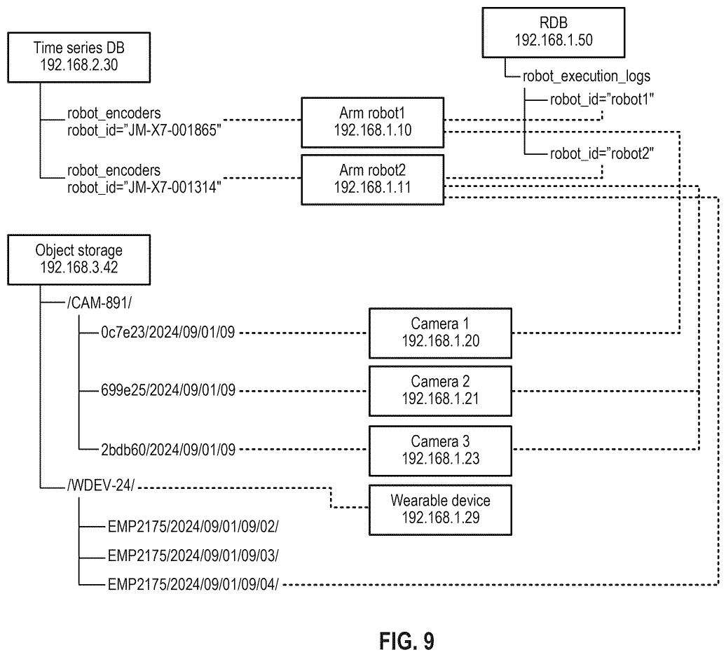

FIG. 9 illustrates the relationships between systems as determined after verifying the contents of the data, according to various embodiments of the present disclosure. Following this analysis, the process transitions back to data exchange measurement status (S2). Corresponding to step S304 in FIG. 6, the system determines whether the relationships between the data sources have been fully established. As illustrated in FIG. 9, once all relationships have been verified, the process concludes. If any relationships have not been fully resolved, the process in FIG. 6 advances to step S305.

At step S305 in FIG. 6, the system queries the user about any relationships that could not be automatically determined. Upon receiving the user's input, the process ends. When the user executes a query such as “What caused the arm robot 2 to stop?,” a data source selector (not shown) may identify relevant data associated with arm robot 2. As indicates in bold text in FIG. 9, the relevant data may comprise data from the time series database for “JM-X7-001314,” data from the RDB's robot_execution_logs table for robot_id is “robot2,” and data stored in object storage stored at paths “/CAM-891/699e25/2024/09/01/09” and “/WDEV-24/EMP2175/2024/09/01/09/04.” In embodiments, the identified relevant data may be compiled into a related data sources list. An execution code generator (not shown) may then use the related data sources list, e.g., to generate the code to perform the ETL to retrieve the relevant data.

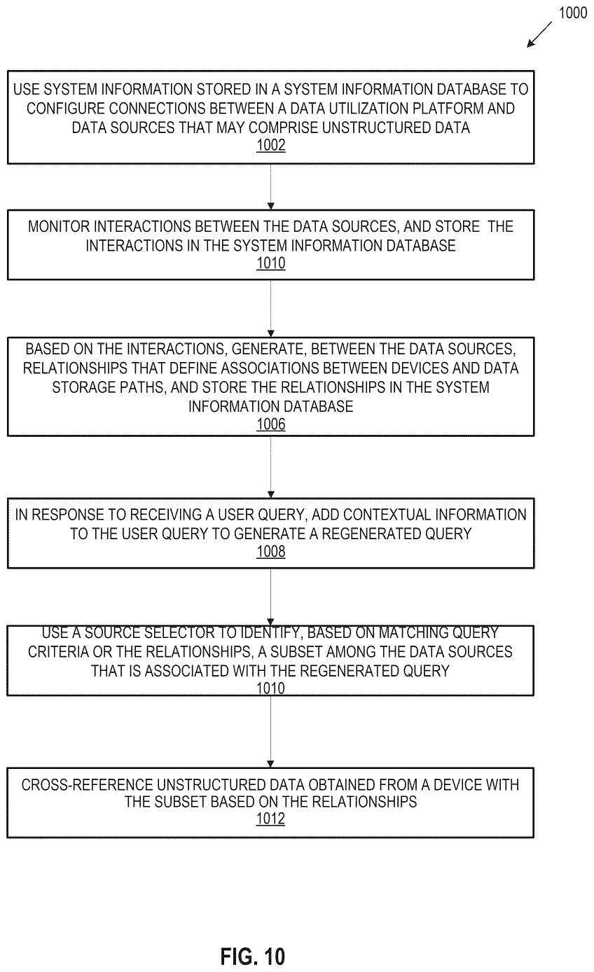

FIG. 10 is a flowchart illustrating an exemplary process for utilizing data from multiple data sources according to various embodiments of the present disclosure. Process 1000 may start at step 1002, when system information that has been stored in a system information database is used to configure connections between a data utilization platform and any number of data sources, which may comprise unstructured data.

At step 1004, a data utilization platform may monitor interactions between those data sources and store them in the system information database.

At step 1006, the data utilization platform may generate relationships between the data sources based on the interactions and store the relationships in the system information database. In embodiments, the relationships may define associations between devices and data storage paths.

At step 1008, in response to receiving a user query, contextual information is added to the user query to generate a regenerated query.

At step 1010, a source selector may be used to identify, e.g., based on matching query criteria or the relationships, a subset among the data sources, the subset being associated with the regenerated query.

Finally, at step 1012, based on the relationships, unstructured data that has been obtain from a device may be cross-referenced with the subset.

One skilled in the art shall recognize that: (1) certain steps may optionally be performed; (2) steps may not be limited to the specific order set forth herein; (3) certain steps may be performed in different orders; and (4) certain steps may be done concurrently.

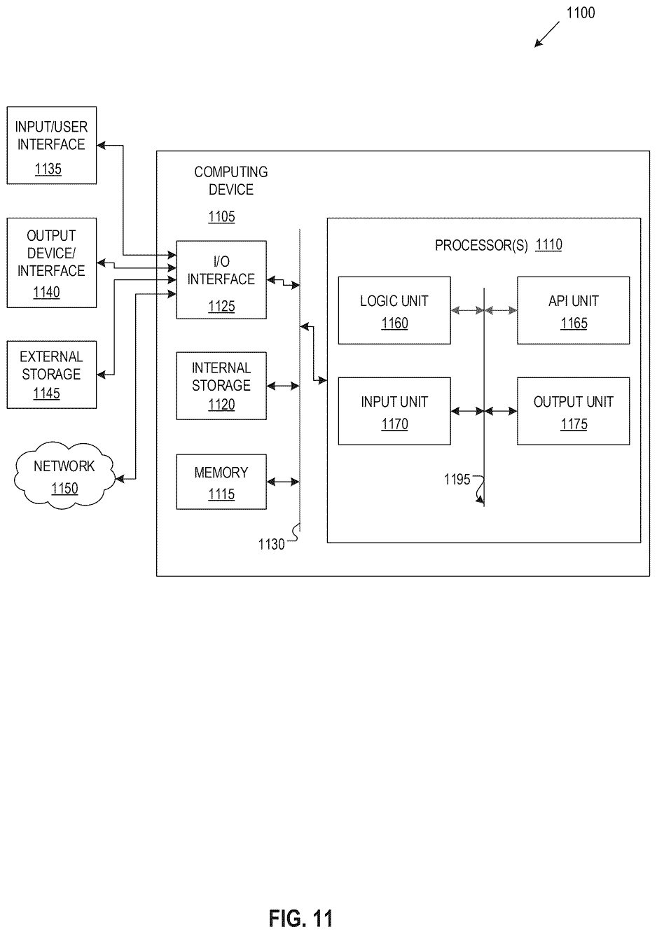

FIG. 11 illustrates an example computing environment with an example computer device suitable for use in some example implementations, according to various embodiments of the present disclosure. Computer device 1105 in computing environment 1100 can include one or more processing units, cores, or processors 1110, memory 1115 (e.g., RAM, ROM, and/or the like), internal storage 1120 (e.g., magnetic, optical, solid-state storage, and/or organic), and/or I/O interface 1125, any of which can be coupled on a communication mechanism or bus 1130 for communicating information or embedded in the computer device 1105. I/O interface 1125 is also configured to receive images from cameras or provide images to projectors or displays, depending on the desired implementation.

Computer device 1105 can be communicatively coupled to input/user interface 1135 and output device/interface 1140. Either one or both of input/user interface 1135 and output device/interface 1140 can be a wired or wireless interface and can be detachable. Input/user interface 1135 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1140 may include a display, television, monitor, printer, speaker, braille, or the like. In some example implementations, input/user interface 1135 and output device/interface 1140 can be embedded with or physically coupled to the computer device 1105. In other example implementations, other computer devices may function as or provide the functions of input/user interface 1135 and output device/interface 1140 for a computer device 1105.

Examples of computer device 1105 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1105 can be communicatively coupled (e.g., via I/O interface 1125) to external storage 1145 and network 1150 for communicating with any number of networked components, devices, and systems, including one or more computer devices of the same or different configurations. Computer device 1105 or any connected computer device can be functioning as, providing services of, or referred to as a server, client, thin server, general machine, special-purpose machine, or another label.

I/O interface 1125 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1100. Network 1150 can be any network or combination of networks (e.g., the Internet, local area network, wide area network, a telephonic network, a cellular network, a satellite network, and the like).

Computer device 1105 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1105 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1110 can execute under any operating system (OS) (not shown), in a native or virtual environment. One or more applications can be deployed that include logic unit 1160, application programming interface (API) unit 1165, input unit 1170, output unit 1175, and inter-unit communication mechanism 1195 for the different units to communicate with each other, with the OS, and with other applications (not shown). The described units and elements can be varied in design, function, configuration, or implementation and are not limited to the descriptions provided. Processor(s) 1110 can be in the form of hardware processors such as central processing units (CPUs) or a combination of hardware and software units.

In some example implementations, when information or an execution instruction is received by API unit 1165, it may be communicated to one or more other units (e.g., logic unit 1160, input unit 1170, output unit 1175). In some instances, logic unit 1160 may be configured to control the information flow among the units and direct the services provided by API unit 1165, input unit 1170, and output unit 1175, in some example implementations described above. For example, the flow of one or more processes or implementations may be controlled by logic unit 1160 alone or in conjunction with API unit 1165. The input unit 1170 may be configured to obtain input for the calculations described in the example implementations, and the output unit 1175 may be configured to provide output based on the calculations described in example implementations.

Processor(s) 1110 can be configured to execute a method or computer instructions which can involve using system information stored in a system information database to configure connections between a data utilization platform and data sources and monitoring one or more interactions between the data sources, and storing the one or more interactions in the system information database, as described, for example, with respect to FIG. 1, FIG. 3, and FIG. 10.

Processor(s) 1110 can be configured to execute a method or computer instructions which can involve generating relationships between the data sources based on the one or more interactions and storing the relationships in the system information database, at least one of the data sources may comprise unstructured data, wherein the relationships define associations between devices and data storage paths, as described, for example, with respect to FIG. 1, FIG. 6, and FIG. 10.

Processor(s) 1110 can be configured to execute a method or computer instructions which can involve adding contextual information to the user query, in response to receiving a user query, to generate a regenerated query; using a source selector to identify, based on matching query criteria or the relationships, a subset among the data sources, the subset being associated with the regenerated query, which may comprise a relevant timestamp, a robot ID, or system status information; and cross-referencing unstructured data, which has been obtained from a device, with the subset based on the relationships. Cross-referencing unstructured data may eliminate a need to train a computer vision model for object detection to interpret content captured by camera data, as described, for example, with respect to FIG. 1 and FIG. 10.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for utilizing data from multiple data sources, the method comprising:
using system information stored in a system information database to configure connections between a data utilization platform and data sources;
monitoring one or more interactions between the data sources, and storing the one or more interactions in the system information database;
generating relationships between the data sources based on the one or more interactions and storing the relationships in the system information database, at least one of the data sources comprising unstructured data, wherein the relationships define associations between devices and data storage paths;
in response to receiving a user query, adding contextual information to the user query to generate a regenerated query;
using a source selector to identify, based on matching query criteria or the relationships, a subset among the data sources, the subset being associated with the regenerated query; and
cross-referencing unstructured data, which has been obtained from a device, with the subset based on the relationships.

2. The method according to claim 1, wherein the one or more interactions comprise at least one of an API request, sensor data, a system log, or an operational instruction between the data sources through an API gateway or a network scanning unit.

3. The method according to claim 1, wherein cross-referencing unstructured data eliminates a need to train a computer vision model for object detection to interpret content captured by camera data

4. The method according to claim 1, further comprising associating data from a wearable device with corresponding system instructions based on the one or more interactions recorded in the system information database.

5. The method according to claim 1, wherein generating the relationships is based on at least one of a data exchange pattern or a unique identifier from the system information, the unique identifier comprising at least one of a system ID, a port number, an IP address, or a temporal alignment of two or more interactions.

6. The method according to claim 1, wherein the regenerated query comprises at least one of a relevant timestamp, a robot ID, or system status information, wherein the system information comprises at least one of a system name, a system ID, an IP address, a port number, an installation location, or a related operation, and wherein the data sources comprise at least one of a relational database, a time series database, video data, or image data.

7. The method according to claim 1, wherein attributes of the one or more interactions comprise at least one of a source address, a destination address, an execution time, a data size, or a frequency of exchange, an IP address, a MAC address, a database table name, a column name, or a path in an object storage system.

8. The method according to claim 1, further comprising prompting a user to provide additional system information during a configuration of the connections between the data utilization platform and the data sources.

9. The method according to claim 1, wherein the contextual information is obtained from a context database that comprises information related to at least one of a management resource, a product lifecycle, a manufacturing execution, a database address, a data type, or a directory name.

10. The method according to claim 1, further comprising using the subset to enable an ETL code to retrieve the data from the subset based on the regenerated query, wherein the ETL code is generated in response to the regenerated query and the subset to extract, transform, and load data into a user-accessible format.

11. A system for utilizing data from multiple data sources, the system comprising:
a system information database configured to store system information and interactions between data sources;
a data utilization platform comprising:
a system connection configuration unit configured to use the system information stored in the system information database to configure connections between the data utilization platform and the data sources;
a data exchange measurement unit configured to monitor the interactions through an API gateway or a network scanning unit and to store the interactions in the system information database;
an inter-system relationship configuration unit configured to generate relationships between the data sources based on the interactions stored in the system information database, wherein at least one of the data sources comprises unstructured data, and wherein the relationships define associations between devices and data storage paths;
a context addition unit configured to add contextual information from a context database to a user query, thereby generating a regenerated query; and
a data source selector configured to identify, based on matching query criteria or the relationships, a subset of data sources associated with the regenerated query, wherein the data utilization platform is configured to associate unstructured data, which has been obtain from a device, with the subset based on the relationships.

12. The system according to claim 11, further comprising an execution code generator configured to generate ETL code to retrieve data from the subset based on the regenerated query.

13. The system according to claim 11, wherein the interactions comprise at least one of an API request, sensor data, a system log, or an operational instruction between the data sources through an API gateway or a network scanning unit.

14. The system according to claim 11, wherein associating the unstructured data with the subset eliminates a need to train a computer vision model for object detection to interpret content captured by camera data.

15. The system according to claim 11, wherein the data utilization platform is further configured to associate data from a wearable device with corresponding system instructions based on the interactions recorded in the system information database.

16. The system according to claim 11, wherein the inter-system relationship configuration unit generates the relationships based on at least one of a data exchange pattern or a unique identifier from the system information, the unique identifier comprising at least one of a system ID, a port number, an IP address, or a temporal alignment of two or more of the interactions.

17. The system according to claim 11, wherein the regenerated query comprises at least one of a relevant timestamp, a robot ID, or system status information, wherein the system information comprises at least one of a system name, a system ID, an IP address, a port number, an installation location, or related operations, and wherein the data sources comprise at least one of a relational database, a time series database, video data, or image data.

18. The system according to claim 11, wherein attributes of the interactions comprise at least one of a source address, a destination address, an execution time, a data size, a frequency of exchange, an IP address, a MAC address, a database table name, a column name, or a path in an object storage system.

19. The system according to claim 11, wherein the context database comprises information related to at least one of a management resource, a product lifecycle, a manufacturing execution, a database address, a data type, or a directory name.

20. A non-transitory computer-readable medium for storing instructions for executing a process, the instructions comprising:
using system information stored in a system information database to configure connections between a data utilization platform and data sources;
monitoring one or more interactions between the data sources;
storing the one or more interactions in the system information database;
generating relationships between the data sources based on the one or more interactions and storing the relationships in the system information database, at least one of the data sources comprising unstructured data, wherein the relationships define associations between devices and data storage paths;
in response to receiving a user query, add contextual information to the user query to generate a regenerated query; and
using a source selector to identify based on matching query criteria or the relationships a subset among the data sources, the subset being associated with the regenerated query; and
cross-referencing unstructured data, which has been obtain from a device, with the subset based on the relationships.
